(19) United States
(12) Patent Application Publication
(10) Pub. No.: US 2016/0078151 A1
(43) Pub. Date: Mar. 17, 2016

(54) MODELING OF BLENDS ON A SOLID MODEL OF A POCKET

(71) Applicants: Yong Feng ZHAO, Zhuji City, Zhejiang (CN); Hui QIN, Shanghai City, Shanghai (CN); Xiuchang LI, Shanghai (CN); James Joseph WOJCIK, Cincinnati, OH (US); Derek ENGLAND, Corona, CA (US); Feng YU, Irvine, CA (US)

(72) Inventors: Yong Feng Zhao, Zhuji City (CN); Hui Qin, Shanghai City (CN); Xiuchang Li, Shanghai (CN); James Joseph Wojcik, Cincinnati, OH (US); Derek England, Corona, CA (US); Feng Yu, Irvine, CA (US)

(21) Appl. No.: 14/889,481

(22) PCT Filed: May 24, 2013
(86) PCT No.: PCT/CN2013/076226

§ 371 Date: Nov. 6, 2015

(51) Int. Cl. G06F 17/50

(52) U.S. Cl. CPC G06F 17/50

(57) ABSTRACT

Methods for accurately modeling blends in a solid model and corresponding systems and computer-readable mediums. A method includes receiving a solid model including a plurality of faces and identifying a pocket from the plurality of faces, including one or more pocket edges to be blended. The method includes performing an analyze pockets process on the pocket and identifying at least one of a tool type, a tool method, or a tool dimension for machining the pocket. The method includes performing a blend pocket process to model blends on the pocket edge and adding a blend to the solid model at the pocket edges, according to the blend pocket process, to produce a modified solid model. The method includes displaying the modified solid model by the data processing system.

### RELATED APPLICATION

This patent document claims priority under 35 U.S.C. §119 and all other benefits from PCT Application No. PCT/CN2013/076226, filed May 24, 2013, the content of which is hereby incorporated by reference to the extent permitted by law.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include methods for accurately modeling blends in a solid model and corresponding systems and computer-readable mediums. A method includes receiving a solid model including a plurality of faces and identifying a pocket from the plurality of faces, including one or more pocket edges to be blended. The method includes performing an analyze pockets process on the pocket and identifying at least one of a tool type, a tool method, or a tool dimension for machining the pocket. The method includes performing a blend pocket process to model blends on the pocket edges and adding a blend to the solid model at the pocket edges, according to the blend pocket analysis, to produce a modified solid model. The method includes displaying the modified solid model by the data processing system.

The foregoing has outlined rather broadly the features and technical advantages of the present disclosure so that those skilled in the art may better understand the detailed description that follows. Additional features and advantages of the disclosure that will be described hereinafter form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIGS. 2A-2F illustrate examples of solid-model pockets;

FIGS. 3A-3C illustrate examples of solid-model pockets with an additional feature;

FIGS. 4A-4C illustrate examples of solid-model pockets with an overhang;

FIGS. 5A-5B illustrate examples of solid-model pockets with a shallow wall; and

FIG. 6 illustrates a flowchart of a process in accordance with disclosed embodiments.

### DETAILED DESCRIPTION

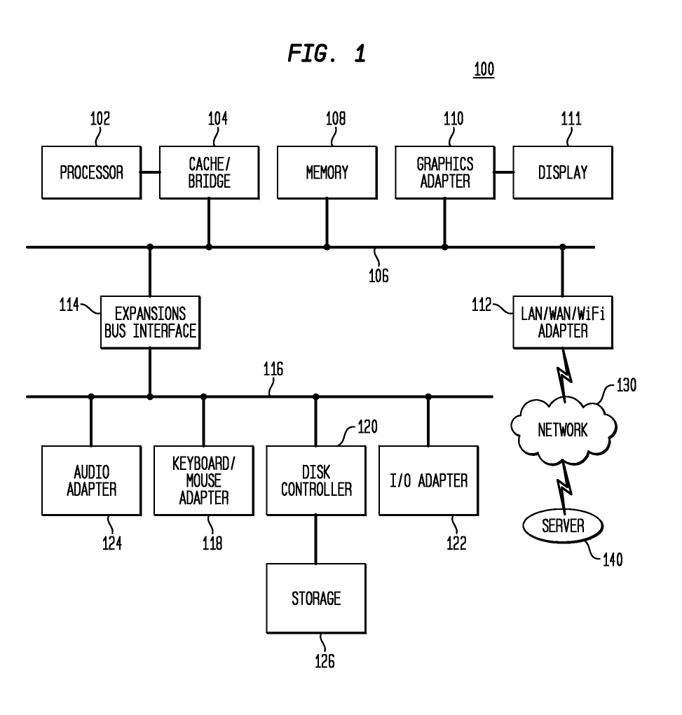

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In computer solid modeling, normal blending commands do not consider all the tooling that could be used to create a machined pocket, and therefore do not always model the blends as they would be manufactured. That is, the pocket and its blends may be visualized in a CAD or PDM system in a manner that does not accurately reflect how the workpiece will or should be actually machined. Disclosed embodiments provide systems and methods that enable users to easily and more accurately model blends on the internal edges of pockets, i.e., blends that will better represent the actual pocket geometry as it will be machined.

Note that while this disclosure uses the term “blending,” many of those of skill in the art use the terms ‘filleting’ or ‘filleting and rounding’ to describe the softening of sharp edges. This disclosure may use these terms interchangeably, and the disclosed techniques apply regardless of the specific term used for this concept. As used herein, a “pocket” is defined as at least one floor face and one or more wall faces in a solid model and its corresponding machined workpiece. Note that “floor” and “wall” are not intended to imply limitations with respect to the orientation of these features; these terms refer to any faces connected by one or more edges.

FIG. 1 depicts a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

In a CAD solid modeling system, blends are usually applied to edges or between connecting faces of a pocket, without regard for particular geometric details of the whole pocket, or the tools and methods used to manufacture the pocket. For some cases, this results in a solid model that does not accurately represent the final physical pocket as it will be manufactured.

Manufacturers may take extraordinary steps to machine the pocket as it is modeled, even though the design would be tolerant of changes that would be easier and less expensive to manufacture. The ability to model the blends as they would be machined, as disclosed herein, reduces or eliminates this unnecessary work and expense in manufacturing.

Shallow pocket walls cause another problem in some systems when they are blended without consideration of how they will be machined. For a blend that has a radius larger than the pocket depth, the modeler may have to adjust the dimensions of the pocket so that the designed edge locations are correct after blending.

An additional problem of other systems is that if the model does not represent the final part, accurate weight estimates cannot be made using the model. This is an important issue for products where weight is a critical factor in product performance.

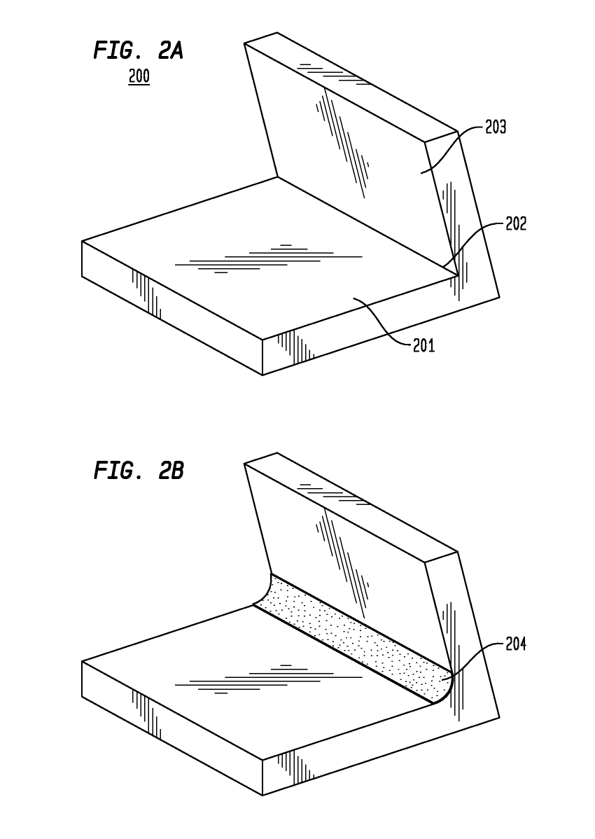

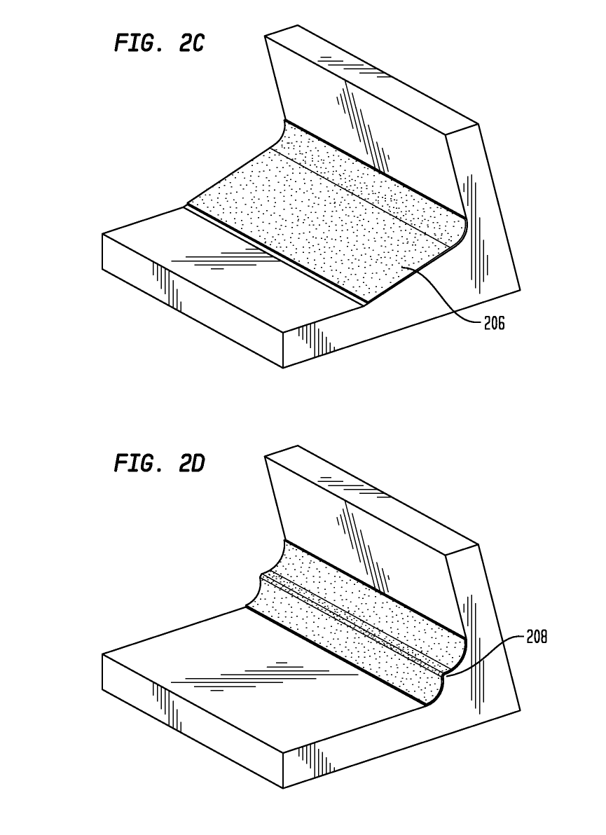

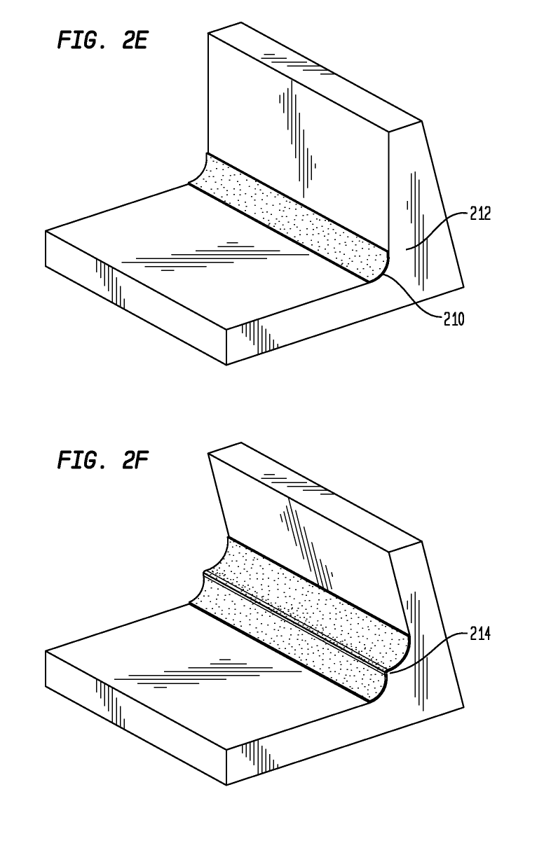

FIGS. 2A-2F illustrate examples of solid-model pockets.

FIG. 2A illustrates a solid model 200 having a pocket with an angled wall formed by faces 201 (floor) and 203 (wall). Note that there is no blending or other softening of the sharp edge 202 and acute angle between the base and the wall.

FIG. 2B illustrates a pocket with a modeled blend 204 using conventional CAD blending and visualization techniques. In actual manufacturing, however, this blend could be machined only by using a spherical mill. An end mill is the preferred tool for machining a pocket, and if an end mill were used for machining this pocket, it could produce a number of different results.

FIG. 2C illustrates one possible result of machining the pocket of FIG. 2A using an end mill. Note that the resulting manufactured blend 206 is much shallower than presented using conventional blending and visualization.

FIG. 2D illustrates another possible result of machining the pocket of FIG. 2A using an end mill. Note that the resulting manufactured blend is shallower than presented using conventional blending and visualization and includes an irregular shape 208.

FIG. 2E illustrates another possible result of machining the pocket of FIG. 2A using an end mill. Note that to properly produce the blend 210, the wall 212 has been moved to a vertical position.

FIG. 2F illustrates another possible result of machining the pocket of FIG. 2A using an end mill. Note that the resulting manufactured blend is shallower than presented using conventional blending and visualization and includes an irregular shape 214.

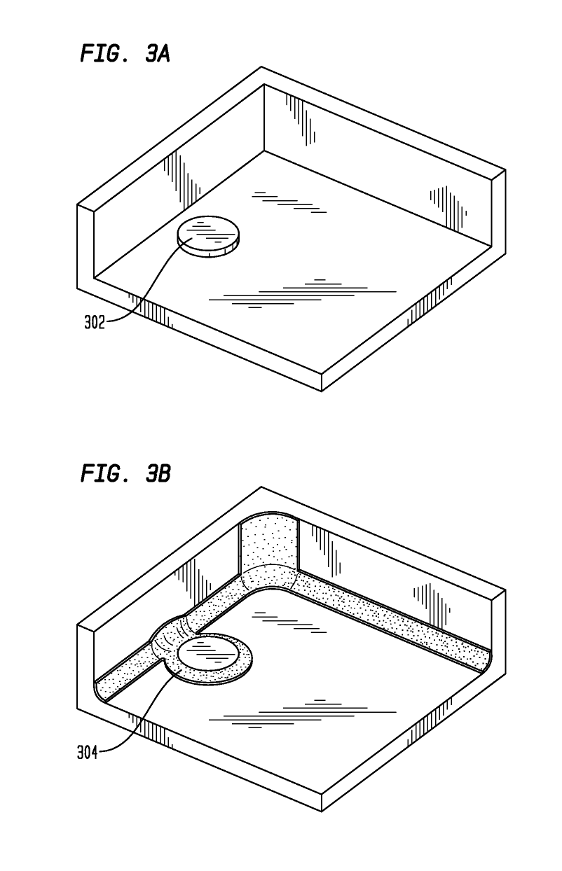

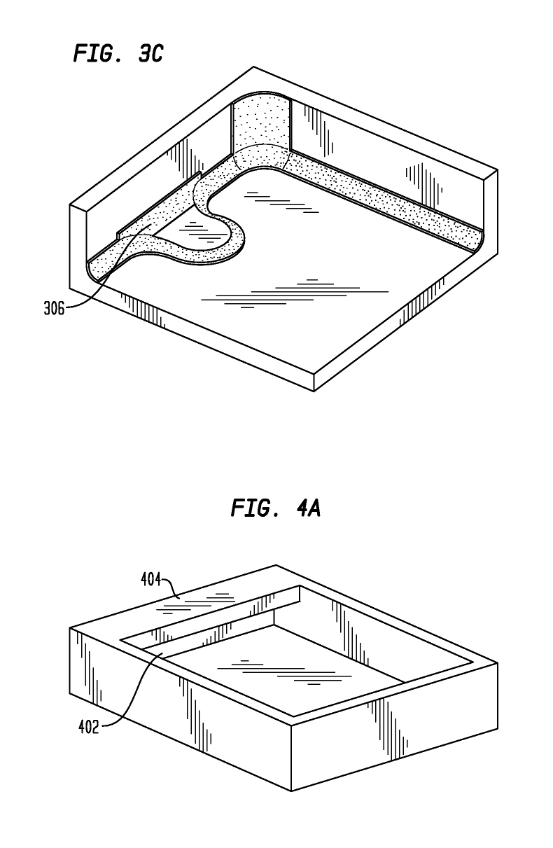

FIGS. 3A-3C illustrate examples of solid-model pockets with an additional feature.

FIG. 3A illustrates a pocket with a wall and a floor boss 302 near the wall. Note that there is no blending or other softening of the sharp edges between the base and the wall or the boss 302.

FIG. 3B illustrates a pocket with modeled blends 304 using conventional CAD blending and visualization techniques. In actual manufacturing, again, this blend could be machined only by using a spherical mill. An end mill is the preferred tool for machining a pocket, and if an end mill were used for machining this pocket, it could produce a number of different results.

FIG. 3C illustrates one possible result of machining the pocket of FIG. 3A using an end mill. Note that the resulting manufactured blend 306 is much different than the blend presented using conventional blending and visualization, particularly between the boss and the wall.

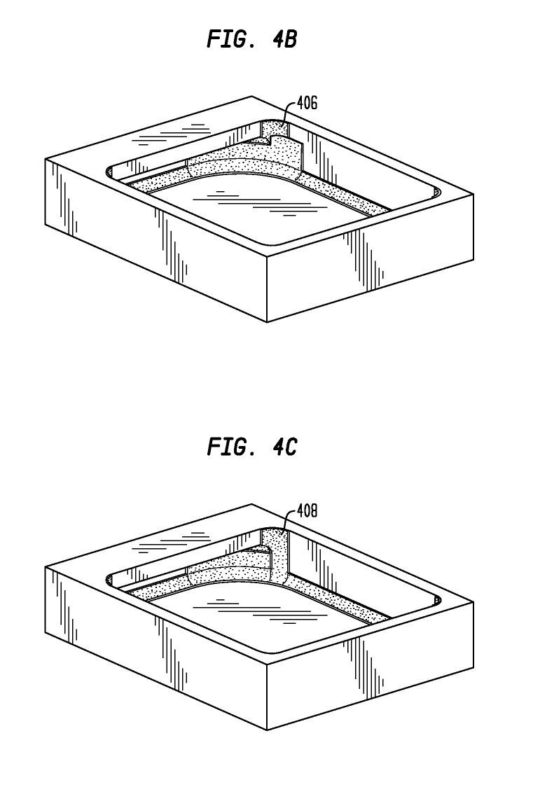

FIGS. 4A-4C illustrate examples of solid-model pockets with an overhang.

FIG. 4A illustrates a pocket with a wall 402 and an overhang 404 extending from the wall 402 (and running between other walls) using conventional CAD blending and visualization techniques. Note that there is no blending or other softening of the sharp edges between the base and the wall 402 or the overhang 404.

FIG. 4B illustrates a pocket with an overhang using conventional CAD blending and visualization techniques. In actual manufacturing, more modeling operations would be necessary to correct the detail 406 at the ends of the overhang, for example. Using a T cutter and an end mill, this pocket could not really be machined as shown in FIG. 4B.

FIG. 4C illustrates a pocket with an overhang as would be machined using the correct application of a T cutter and an end mill to machine the pocket. Note the more-accurate blend detail 408.

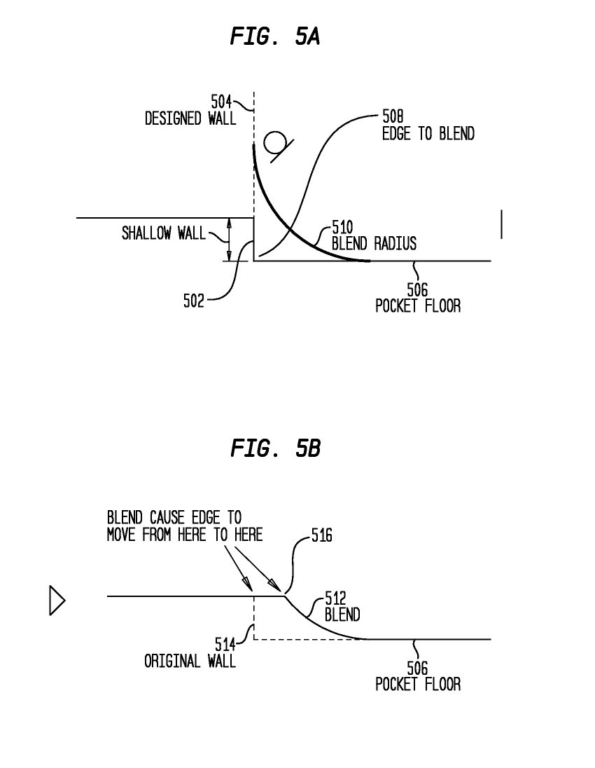

FIGS. 5A-5B illustrate an example of a solid-model pocket with a shallow wall. To form a blend of the edge 508 between the shallow wall 502 and the pocket floor 506, with a given blend radius 510, many systems will extend the wall to meet the blend radius, as shown in FIG. 5B, to reflect a blend with respect to a virtual designed wall 504.

FIG. 5B illustrates that, when blend 512 is machined, it effectively moves the top edge of the original wall at 514 to a new location at 516. The modeled blend could cause the edge to move, thus violating the designed location of the edge. The original location of the edge must be maintained.

The figures described above show just four typical examples of discrepancies that can exist between a blended model of a pocket and the actual physical pocket that is manufactured.

Disclosed embodiments allow the user to identify pocket details that require consideration of machining when blending a pocket so that the system can then model the blends as closely as possible to how they will be created when the pocket is machined.

The system uses an “analyze pockets” process that finds details of which the user needs to be aware when blending the pocket, i.e., undercuts, angled walls, and tool inaccessibility areas. This information is needed for the proper selection of the tools and methods that will be used to machine the pocket. These areas are listed, and indicated graphically, so that the user can easily identify these areas of concern. The information is then used to specify tool types, methods, and tool dimensions for machining, and thus result in accurate blends of the internal edges of the pockets.

Undercuts and acutely angled walls can be found (if specified) regardless of what tool and tool dimensions are specified. Tool inaccessibility areas can include floor bosses, particularly for end mill and spherical mill tools. Tool inaccessibility areas can include undercut height, such as when a T cutter tool is too thick to machine the undercut. Tool inaccessibility areas can include reach, such as whether a T cutter tool diameter and neck diameter are such that the cutter can reach the back wall of the undercut. Tool inaccessibility areas can include access clearance, such as whether a T cutter tool will violate a part wall. Tool inaccessibility areas can include other general access problems where a given tool may not be able to properly machine the blend area.

The system can receive other input to use in the analysis processes described herein. For example, the pocket floor faces (excluding bosses) can be input to the both the blend pocket and analyze pockets processes. Users can specify the final Wall-to-Wall blend radius or a tool diameter and corner clearance. The final blend radius can be produced from the specified tool diameter and the specified corner clearance (R=D/2+CC). If the user does not specify the corner clearance, then the Wall-to-Wall blend radius can be used as the tool radius (the tool diameter divided by 2). However, if the user specifies a corner clearance, then the Wall-to-Wall radius can be designated as the tool diameter divided by 2, plus the corner clearance. The corner clearance is the difference between the desired corner blend radius and the cutting tool radius, and in many cases is actually the radius of the tool path at the corner. The Wall-to-Wall radius generally is not input by the user, but the system can calculate it and present it in the dialog for information.

When pockets overlap, the explicit selection of one floor face can cause the system to also automatically infer the floor faces of the overlapping pockets, and all floor faces can be shown as selected whether they were explicitly selected or inferred. The user will be able to deselect any of the selected floor faces, whether explicitly selected or inferred (because each pocket may require a different tool, even if overlapping).

Upon selection of the floor faces, the system can automatically select wall faces and highlight them, for example in a secondary selection color. If the automatic wall selection is not what the user wants, wall faces can be deselected or added as desired by the user.

The tool to be used for machining, and its dimensions, can be input to any of the processes described herein.

The system uses a “blend pocket” process to model blends on the edges of a pocket by specifying the tool or tools that will be used, how the tool will be applied in some cases, and the tool dimensions. Only “concave” edges will be blended, i.e., edges where blend material is added, not the “convex” edges where material would be removed. As used herein, a “concave” edge is defined as the edge between two faces that have an angle of less than 180° between them at the edge.

Prior to actually blending the pocket, the blend pocket process can compare the specified tool to the dimensions of the pocket to detect and report problem areas, e.g., tool dimensions that are incompatible, areas of the pocket where the tool will not fit, etc. The blend pocket process allows the user to optionally enter a corner clearance dimension so that the tool path will not have to include a sharp turn at a corner.

The system can then blend multiple edges of the pocket in one operation, using minimal geometric input.

The blend pocket process automatically considers tool inaccessibility areas in the pocket. When possible it creates “fill” material in the model as necessary to accurately represent the as-machined state.

Blend Pocket honors design intent by only adding material to create the blends, i.e., never removing material from the model.

The resulting model of the blended pocket will closely or exactly depict the actual pocket as it will be manufactured.

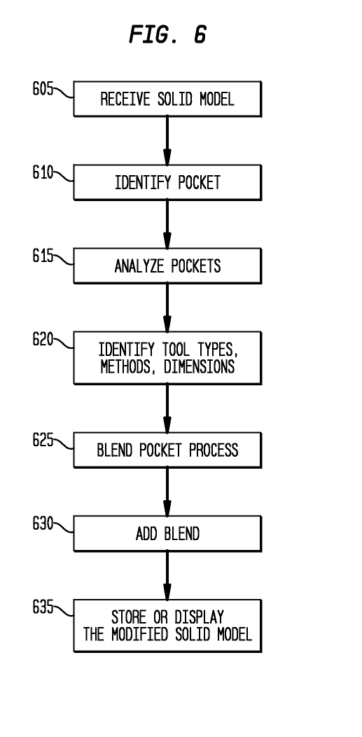

FIG. 6 illustrates a flowchart of a process in accordance with disclosed embodiments that may be performed, for example, by one or more CAD, PLM, or PDM systems (referred to generically herein as “the system”).

The system receives a solid model including a plurality of faces (605). “Receiving,” as used herein, can include loading from storage, receiving from another device or process, receiving via an interaction with a user, and otherwise. The faces can be part of such features as a wall or a floor of the solid model.

The system identifies a pocket, from the plurality of faces, which includes one or more pocket edges to be blended (610). The system can identify the pocket and display it to a user, or the system can receive a selection of one or more faces, from the user, that identifies the pocket. Typically the pocket has floor faces and wall faces. Many pockets have multiple floor faces and multiple wall faces. Many common pockets will have one floor face and multiple wall faces. As described herein, in some cases, the system can receive a selection of a floor face and automatically identify one or more wall faces that form the pocket. There can be one or more pocket edges which are the edges between, for example, the floor and the walls that form the pocket, and the edges between walls of the pocket.

The system performs an analyze pockets process on the pocket (615) including displaying pocket details to the user. The pocket details can include undercuts, angled walls, or tool inaccessibility areas.

The system can identify tool types, tool methods (how the tool with be used or the machining performed), or tool dimensions for machining the pocket (620). This can be performed automatically by the system, based on the pocket details, or can include receiving corresponding selections from the user.

The system performs a blend pocket process to model blends on the pocket edge(s) (625). This can be performed according to the identified tool types, methods, or tool dimensions. This can include comparing the specified tool to the dimensions of the pocket to detect and report problem areas. This can includes receiving a corner clearance dimension so that the tool path will not have to include a sharp turn at a corner.

The system adds blends to the solid model at the pocket edges, according to the blend pocket process, to produce a modified solid model (630).

The system stores or displays the modified solid model (635).

Of course, those of skill in the art will recognize that, unless specifically indicated or required by the sequence of operations, certain steps in the processes described above may be omitted, performed concurrently or sequentially, or performed in a different order.

Blending is generally the most time-consuming activity when modeling a part using CAD. The ability to do it easily and more accurately using disclosed embodiments is a significant enhancement to productivity.

Disclosed embodiments add functionality to CAD systems that analyze a pocket to determine if it has walls with overhangs (i.e., undercut walls), angled walls, and/or areas of tool inaccessibility. Various embodiments add filleting functionality that uses the specification of a tool type, machining method, or tool dimensions to create the blends in a pocket. Disclosed embodiments can blend the internal concave edges of a pocket as they would be created by machining the pocket using a particular type of tool, a specified tool orientation during cutting passes, and specified tool dimensions.

Various embodiments can automatically detect and blend nested pockets.

In some cases, the analyze pocket process can to provide dimensional information that can be used to select a tool for the particular pocket(s) analyzed. E.g., “The tool reach of the T Cutter must be greater than 18 mm,” or “The flute length of the T Cutter must be less than 24 mm.”

In some cases, the system allows the user to select a tool from a standard tool catalog during the drafting process, and can suggest a likely tool or tools to use for the particular pocket selected.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for accurately modeling blends in a solid model, the method performed by a data processing system and comprising:
receiving a solid model including a plurality of faces by the data processing system;
identifying a pocket from the plurality of faces, by the data processing system, including a pocket edge to be blended;
performing an analyze pockets process on the pocket by the data processing system;
identifying at least one of a tool type, a tool method, or a tool dimension for machining the pocket, by the data processing system;
performing a blend pocket process, by the data processing system, to model blends on the pocket edge;
adding a blend to the solid model at the pocket edge, by the data processing system and according to the blend pocket process, to produce a modified solid model; and
displaying the modified solid model by the data processing system.

2. The method of claim 1, wherein the pocket edge is an edge between a floor face and a wall face of the solid model.

3. The method of claim 1, wherein the analyze pockets process includes displaying pocket details to a user, the pocket details including at least one of undercuts, angled walls, or tool inaccessibility areas.

4. The method of claim 1, wherein the blend pocket process is performed according to the identified tool type, tool method, or tool dimension.

5. The method of claim 1, wherein the blend pocket process includes comparing an identified tool type and tool dimension to a dimension of the pocket to detect and report problem areas.

6. The method of claim 1, wherein the blend pocket process is performed according to a corner clearance dimension.

7. The method of claim 1, wherein the analyze pockets process includes displaying tool inaccessibility areas to a user, the tool inaccessibility areas including at least one of floor bosses, undercut height, reach, and access clearance.

8. A data processing system comprising:
a processor; and
an accessible memory, the data processing system particularly configured to
receive a solid model including a plurality of faces;
identify a pocket from the plurality of faces, including a pocket edge to be blended;
perform an analyze pockets process on the pocket;
identify at least one of a tool type, a tool method, or a tool dimension for machining the pocket;
perform a blend pocket process to model blends on the pocket edge;
add a blend to the solid model at the pocket edge, according to the blend pocket process, to produce a modified solid model; and
display the modified solid model.

9. The data processing system of claim 8, wherein the pocket edge is an edge between a floor face and a wall face of the solid model.

10. The data processing system of claim 8, wherein the analyze pockets process includes displaying pocket details to a user, the pocket details including at least one of undercuts, angled walls, or tool inaccessibility areas.

11. The data processing system of claim 8, wherein the blend pocket process is performed according to the identified tool type, tool method, or tool dimension.

12. The data processing system of claim 8, wherein the blend pocket process includes comparing an identified tool type and tool dimension to a dimension of the pocket to detect and report problem areas.

13. The data processing system of claim 8, wherein the blend pocket process is performed according to a corner clearance dimension.

14. The data processing system of claim 8, wherein the analyze pockets process includes displaying tool inaccessibility areas to a user, the tool inaccessibility areas including at least one of floor bosses, undercut height, reach, and access clearance.

15. A non-transitory computer-readable medium encoded with executable instructions that, when executed, cause one or more data processing systems to:
receive a solid model including a plurality of faces;
identify a pocket from the plurality of faces, including a pocket edge to be blended;
perform an analyze pockets process on the pocket;
identify at least one of a tool type, a tool method, or a tool dimension for machining the pocket;
perform a blend pocket process to model blends on the pocket edge;
add a blend to the solid model at the pocket edge, according to the blend pocket process, to produce a modified solid model; and
display the modified solid model.

16. The computer-readable medium of claim 15, wherein the pocket edge is an edge between a floor face and a wall face of the solid model.

17. The computer-readable medium of claim 15, wherein the analyze pockets process includes displaying pocket details to a user, the pocket details including at least one of undercuts, angled walls, or tool inaccessibility areas.

18. The computer-readable medium of claim 15, wherein the blend pocket process is performed according to the identified tool type, tool method, or tool dimension.

19. The computer-readable medium of claim 15, wherein the blend pocket process includes comparing an identified tool type and tool dimension to a dimension of the pocket to detect and report problem areas.

20. The computer-readable medium of claim 15, wherein the blend pocket process is performed according to a corner clearance dimension.
